(19) United States
(12) Patent Application Publication
(10) Pub. No.: US 2026/0082216 A1
(43) Pub. Date: Mar. 19, 2026

(54) PROVIDING SECURITY KEYS TO A SERVING NETWORK OF A USER EQUIPMENT

(71) Applicant: Lenovo (Singapore) Pte. Limited, Singapore (SG)

(72) Inventors: Andreas Kunz, Ladenburg (DE); Sheeba Backia Mary Baskaran, Friedrichsdorf (DE)

(73) Assignee: Lenovo (Singapore) Pte. Limited, Singapore (SG)

(21) Appl. No.: 19/110,954

(22) PCT Filed: Sep. 27, 2023
(86) PCT No.: PCT/IB2023/059654

§ 371 Date: Mar. 12, 2025

Related U.S. Application Data
(60) Provisional application No. 63/411,478, filed on Sep. 29, 2022.

(51) Int. Cl. H04W 12/04; H04W 8/12; H04W 12/06

(52) U.S. Cl. CPC H04W 12/04; H04W 8/12; H04W 12/06

(57) ABSTRACT

Various aspects of the present disclosure relate to situations where a secure connection is established, e.g., using an application session key, between a user equipment (UE) and an application function (AF) in a home public land mobile network (HPLMN) of the UE. The AF communicates the application session key to an authentication and key management for applications (AKMA) anchor function (AAnF) in the HPLMN, also referred to as a home AAnF (HAAnF). The user can roam with the UE to a visited public land mobile network (VPLMN) and the AAnF transmits the application session key to a network entity in the VPLMN. A security context that includes the application session key is stored in the VPLMN. Any refreshes of the application session key or other keys derived from the application session key are similarly communicated to the AAnF in the HPLMN and a network entity in the VPLMN.

### RELATED APPLICATION

This application claims priority to U.S. patent application Ser. No. 63/411,478 filed Sep. 29, 2022 entitled “Providing Security Keys to a Serving Network of a User Equipment,” the disclosure of which is incorporated by reference herein in its entirety.

### TECHNICAL FIELD

The present disclosure relates to wireless communications, and more specifically to providing security keys to a serving network of a user equipment (UE).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may include one or more public land mobile networks (PLMNs), each of which is a particular geographic area covered by the wireless communications services of a particular service provider. A home public land mobile network (HPLMN) is a PLMN where the subscriber information of a user that subscribes to the wireless communications system is held. Users are able to move (also referred to as roam) to PLMNs other than their HPLMN, and these other PLMNs are referred to as visited public land mobile networks (VPLMNs). A UE also has a serving network, which refers to the PLMN that the UE is located in at any particular time (and may be the HPLMN or a VPLMN).

Service providers oftentimes support legal interception (LI), also referred to as lawful interception. LI refers to a requirement or obligation for appropriate entities, such as law enforcements agencies or government authorities, to be able to intercept communication traffic in the wireless communications system.

### SUMMARY

The present disclosure relates to methods, apparatuses, and systems that support providing security keys to a serving network of a user equipment. A secure connection may be established, e.g., using an application session key, between the UE and an application function (AF) in the HPLMN of the UE. The AF communicates the application session key to an authentication and key management for applications (AKMA) anchor function (AAnF) in the HPLMN, also referred to as a home AAnF (HAAnF). The user can roam with the UE to a VPLMN and the AAnF transmits the application session key to a network entity in the VPLMN. The receiving network entity, or another network entity in the VPLMN, stores a security context that includes the application session key. Any refreshes of the application session key or other keys derived from the application session key are similarly communicated to the AAnF in the HPLMN and a network entity in the VPLMN. By communicating the application session key (or other keys derived from the application session key) to a network entity in the VPLMN, an LI security context that includes these keys is stored in the VPLMN, allowing the VPLMN to support LI.

Some implementations of the method and apparatuses described herein may further include to: receive, from a first network entity in a first network, a first signaling indicating a first request and an application session security key, the apparatus being in the first network; transmit, to a second network entity in a second network, a second signaling indicating a second request and the application session key; receive, from the second network entity, a third signaling indicating acknowledgment of the second request.

In some implementations of the method and apparatuses described herein are further to: detect that the second network supports AKMA; and transmit, in response to detecting that the second network supports AKMA, the second signaling to a visited authentication and key management for applications anchor function (VAAnF) that is the second network entity in the second network. Additionally or alternatively, the second network does not support AKMA and the second network entity comprises a network exposure function (NEF) in the second network.

Additionally or alternatively, the second signaling further indicates an AKMA key identifier (A-KID), an application function identity (AF_ID), a subscription permanent identifier (SUPI), an AKMA application key (KAF), and a KAF expiration time. Additionally or alternatively, the method and apparatus are further to transmit, to the first network entity, a fourth signaling indicating acknowledgment of the first request. Additionally or alternatively, the method and apparatus are further to transmit the second signaling in response to detecting that a UE is roaming in the second network, the application session security key having been established for secure communication between the UE and the first network entity. Additionally or alternatively, the apparatuses implement a HAAnF.

Some implementations of the method and apparatuses described herein may further include to: receive, from a first network entity in a first network, a first signaling indicating a first request and an application session security key, the apparatus being in a second network; transmit, to a second network entity in the second network, a second signaling indicating a second request and the application session key; receive, from the second network entity, a third signaling indicating acknowledgment of the second request.

In some implementations of the method and apparatuses described herein, the method and apparatus are further to: select one of multiple network functions (NFs) in the second network; and transmit the second signaling to the selected one of the multiple NFs, the selected one of the multiple NFs being the second network entity in the second network. Additionally or alternatively, the second signaling further indicates an A-KID, an AF_ID, a SUPI, an KAF, and a KAF expiration time. Additionally or alternatively, the second network entity is one of a unified data management (UDM) function, a unified data repository (UDR), an access and mobility management function (AMF), a session management function (SMF), a policy control function (PCF), an authentication server function (AUSF), and an AAnF. Additionally or alternatively, the method and apparatuses described herein, the method and apparatus are further to cause the apparatus to transmit, to the first network entity, a fourth signaling indicating acknowledgment of the first request. Additionally or alternatively, the application session security key is a security key for secure communication between a UE that is roaming in the second network and an application function in the first network. Additionally or alternatively, the apparatuses implements a NEF.

Some implementations of the method and apparatuses described herein may further include to: receive, from a first network entity in a first network, a first signaling indicating a first request and an application session security key, the apparatus being in the first network; store a legal interception (LI) security context that includes the application session security key; transmit, to the first network entity, a second signaling indicating acknowledgment of the second request.

In some implementations of the method and apparatuses described herein, the second signaling further indicates an A-KID, an AF_ID, a SUPI, an KAF, and a KAF expiration time, and the LI security context further includes the AKMA, the A-KID, the AF_ID, the SUPI, the KAF, and the KAF expiration time. Additionally or alternatively, the method and apparatus are further to: determine that the KAF expiration time has expired; and delete, in response to determining that the KAF expiration time has expired, the LI security context. Additionally or alternatively, the apparatus implements a second network entity that is one of a UDM, UDR, AMF, SMF, PCF, AUSF, and an AAnF. Additionally or alternatively, the application session security key is a security key for secure communication between a UE that is roaming in the first network and an application function in a second network. Additionally or alternatively, the first network entity comprises a NEF.

### BRIEF DESCRIPTION OF THE DRAWINGS

FIG. 1 illustrates an example of a wireless communications system that supports providing security keys to a serving network of a user equipment in accordance with aspects of the present disclosure.

FIG. 2 illustrates an example of deriving an AKMA anchor key after primary authentication that supports providing security keys to a serving network of a user equipment in accordance with aspects of the present disclosure.

FIGS. 3 through 5 illustrate examples of AKMA application key generation from an AKMA anchor key and provisioning to VPLMN that supports providing security keys to a serving network of a user equipment in accordance with aspects of the present disclosure.

FIGS. 6 through 8 illustrate an example of a block diagram of a device that supports providing security keys to a serving network of a user equipment in accordance with aspects of the present disclosure.

FIGS. 9 through 14 illustrate flowcharts of methods that support providing security keys to a serving network of a user equipment in accordance with aspects of the present disclosure.

### DETAILED DESCRIPTION

A UE is able to establish at the application layer a secure connection between the UE and an AF located in the HPLMN. The UE and the AF may use an AKMA application key (K_{AF}) as input to derive another key (e.g., an application session key (K_{Session}), also referred to as an application session security key) used for encryption. For example, transport layer security (TLS) may be used to establish the secure connection between the UE and the AF located in the HPLMN, and a Diffie-Hellman exchange uses the KAF key as input to derive another key used for encryption (e.g., K_{Session}).

LI, which allows an appropriate entity, such as a law enforcement agency or government authority, to intercept communication traffic in the wireless communications system are requirements for many PLMNs. Some AKMA solutions, however, do not address LI in situations in which the UE is roaming (located in a VPLMN) but the AF is located in the HPLMN. For example, one solution is to provide an AF key to the VPLMN but not any further keys derived for an application session, which does not support LI if such further keys are derived for the application session. By way of another example, a solution may expect the VPLMN to support AKMA, but this is not always the case, so situations may arise where there may not be an AAnF in the VPLMN to store the LI security context.

Using the techniques discussed herein, a UE and an AF in the HPLMN of the UE establish a secure connection between each other using, for example, a K_{Session}. The AF uses a push procedure to communicate the K_{Session}, after establishing the secure connection between the UE and the AF in the HPLMN, to an HAAnF in the HPLMN. The user can roam with the UE to a VPLMN and the HAAnF transmits the K_{Session} to a network entity in the VPLMN. For example, if the VPLMN supports AKMA, then the HAAnF transmits the K_{Session} (and optionally additional LI security context) to the VAAnF in the VPLMN, which stores the K_{Session} and any other LI security context. By way of another example, if the VPLMN does not support AKMA, then the HAAnF transmits the K_{Session} (and optionally additional LI security context) to a network exposure function (NEF) in the VPLMN. The NEF then transmits the K_{Session} (and optionally additional LI security context) to another NF in the VPLMN for storage of the K_{Session} (and optionally additional LI security context). Similarly, the AF communicates any refreshes of the K_{Session} or any other keys derived from the K_{Session} for the secure connection between the UE and the AF are communicated to the HAAnF, which communicates any such K_{Session} refreshes or other keys derived from the K_{Session} to the network entity in the VPLMN.

By communicating the K_{Session}, refreshes of the K_{Session}, or other keys derived from the K_{Session} to a network entity in the VPLMN, an LI security context that includes these keys is stored in the VPLMN, which allows the VPLMN to support LI. In contrast, other solutions that provide the KAF to the VPLMN do not allow the VPLMN to support LI if the secure connection uses keys derived from the KAF (such as a K_{Session}). Furthermore, the HAAnF selects to transmit the K_{Session} to a VAAnF in the VPLMN (e.g., if the VPLMN supports AKMA) or to an NEF in the VPLMN (e.g., if the VPLMN does not support AKMA). Accordingly, the techniques discussed herein allow the VPLMN to support LI regardless of whether the VPLMN supports AKMA.

Aspects of the present disclosure are described in the context of a wireless communications system. Aspects of the present disclosure are further illustrated and described with reference to device diagrams and flowcharts.

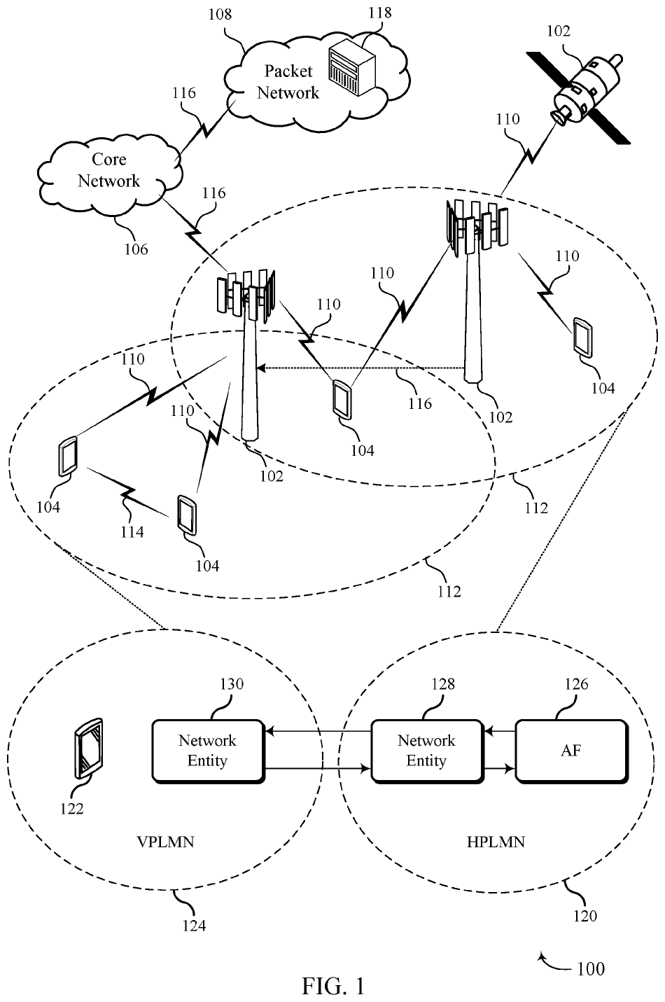

FIG. 1 illustrates an example of a wireless communications system 100 that supports providing security keys to a serving network of a user equipment in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FRI may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FRI may be associated with a first numerology (e.g., μ=0), which includes 15 kHz subcarrier spacing; a second numerology (e.g., (μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 includes an HPLMN 120 that is the HPLMN of a UE 122 (which is an example of a UE 104) and a VPLMN 124 in which the UE 122 is roaming (the VPLMN 124 is the serving network of the UE 122 in this example). The UE 122 and an AF 126 establish a secure connection between each other using, for example, a K_{Session}. The AF 126 uses a push procedure to communicate the K_{Session}, e.g., after establishing the secure connection between the UE 122 and the AF 126, to a network entity 128 in the HPLMN 120 (e.g., an HAAnF). The network entity 128 transmits the K_{Session} to a network entity 130 in the VPLMN 124, such as a VAAnF (if the VPLMN 124 supports AKMA), or an NEF (if the VPLMN 124 does not support AKMA). The NEF may then transmit the K_{Session} to another network entity (not shown) in the VPLMN (e.g., a NF) for storage of the K_{Session}.

A network entity 128 or 130 may be any of a variety of different functions or devices implementing any of a variety of different functions, such as an HAAnF, an NEF, an NF, a VAAnF, a unified data management (UDM) function, a unified data repository (UDR), an access and mobility management function (AMF), a session management function (SMF), a policy control function (PCF), an authentication server function (AUSF), and an authentication and key management for applications anchor function (AAnF), and so forth.

Various communications between the AF 126, network entity 128, network entity 130, other network entities (not shown) in the VPLMN 124, other network entities (not shown) in the HPLMN 120, and so forth are discussed herein. These communications can be made using any of a variety of signaling, such as data or control signaling, using any of various techniques such as RRC, SDAP, PDCP, MAC, and so forth.

The techniques discussed herein address support for AKMA roaming, such as the scenario when the UE 104 is in a VPLMN and trying to access the HPLMN AF. An issue of LI for AKMA roaming is if the UE is roaming in a VPLMN, then the UE builds up a secure tunnel to an AF in the HPLMN and since the credentials used for the encryption are based on the 3GPP derived keys, the VPLMN typically needs to be able to perform LI. This is not possible compared to generic bootstrapping architecture (GBA), where the NAF and tunnel endpoint is located in the VPLMN. Further it cannot be implied that the AF is always in the VPLMN for roaming scenarios, for typical deployments it can be a 3rd party AF in a data network.

If the VPLMN needs to perform LI, then the VPLMN is enhanced to store the SUPI and the encryption key, e.g., with a local AAnF. It has been recommended to only provide the KAF to the VPLMN for the service the UE is currently requesting from the AF. In case the VPLMN is not enhanced but has a strong LI requirement for AKMA, the AF is not to get the KAF and is to get an indication that NULL encryption has to be used.

One solution is to introduce a VAAnF in the VPLMN in order to store the connection details of the UE roaming in that VPLMN to the AF outside that VPLMN.

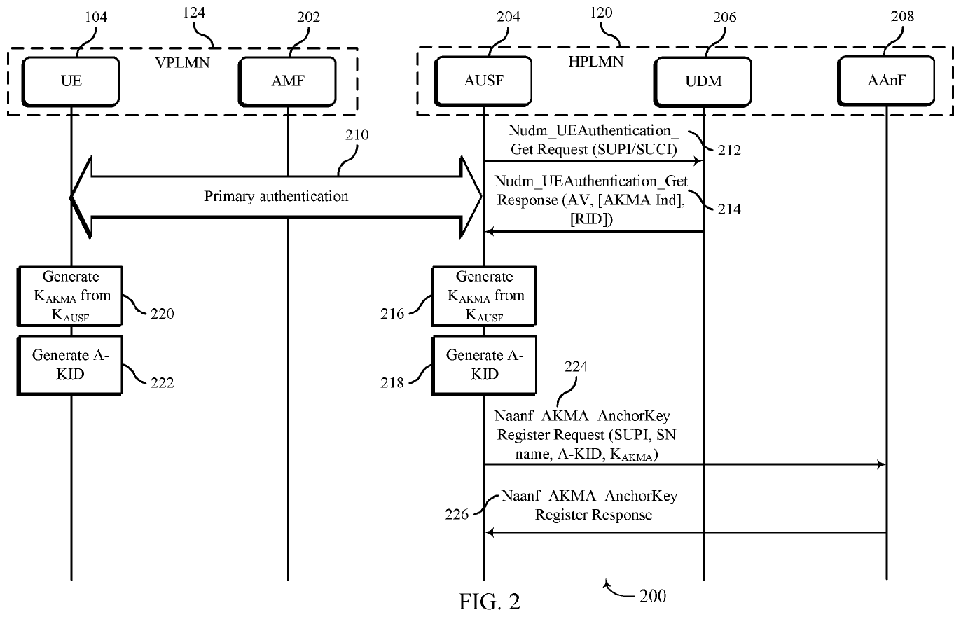

FIG. 2 illustrates an example 200 of deriving an AKMA anchor key (K_{AKMA}) after primary authentication that supports providing security keys to a serving network of a user equipment in accordance with aspects of the present disclosure. The example 200 illustrates a VPLMN 124 that includes a UE 104 and an AMF 202, and an HPLMN 120 that includes an AUSF 204, a UDM 206, and an AAnF 208.

In one or more implementations, there is no separate authentication of the UE 104 to support AKMA functionality. Instead, AKMA reuses the wireless communications system radio access technology (e.g., 5G) primary authentication procedure executed, e.g., during the UE 104 registration to authenticate the UE 104. A successful primary authentication results in an AUSF key (K_{AUSF}) being stored at the AUSF 204 and the UE 104.

During a primary authentication procedure 210, the AUSF 204 interacts with the UDM 206 in order to fetch authentication information such as subscription credentials (e.g., authentication and key agreement (AKA) authentication vectors) and the authentication method using the Nudm_UEAuthentication_Get Request service operation at 212.

In the response at 214, Nudm_UEAuthentication_Get Response, the UDM 206 may also indicate to the AUSF 204 whether the AKMA Anchor key needs to be generated for the UE 104. If the AKMA indication is included, the UDM 206 also includes the routing indicator (RID) of the UE 104.

If the AUSF 204 receives the AKMA indication from the UDM 206, the AUSF 204 stores the K_{AUSF} and generates the K_{AKMA} at 216 and the A-KID from K_{AUSF} at 218 after the primary authentication procedure 210 is successfully completed.

The UE 104 generates the K_{AKMA} at 220 and the A-KID from the K_{AUSF} at 222 before initiating communication with an AKMA Application Function.

After AKMA key material is generated, the AUSF 204 selects the AAnF 208 and at 224 sends the generated A-KID and K_{AKMA} to the AAnF 208 together with the SUPI of the UE 104 using the Naanf_AKMA_KeyRegistration Request service operation. The AAnF 208 stores the latest information sent by the AUSF 204. The AUSF 204 need not store any AKMA key material after delivery to the AAnF 208.

When re-authentication runs, the AUSF 204 generates a new A-KID and a new K_{AKMA}, and sends the new generated A-KID and K_{AKMA} to the AAnF 208. After receiving the new generated A-KID and K_{AKMA}, the AAnF 208 deletes the old A-KID and K_{AKMA} and stores the new generated A-KID and K_{AKMA}.

In addition to the other AKMA related parameters, the AUSF 204 provides also the serving network (SN) name to the AAnF 208 in the HPLMN 120. The SN name is later used to determine whether the UE 104 is roaming and to select an appropriate VAAnF for storing the AKMA connection details.

The AAnF 208 sends the response to the AUSF 204 using the Naanf_AKMA_AnchorKey_Register Response service operation at 226.

The A-KID identifies the K_{AKMA} key of the UE 104. A-KID may be in a network access identifier (NAI) format, e.g., username@realm. The username part includes the RID and the AKMA temporary UE identifier (A-TID), and the realm part includes a home network identifier. The A-TID may be derived from K_{AUSF}.

The AUSF 204 may use the RID received from the UDM 206 to derive A-KID. The chance of A-TID collision is not zero but is practically low as the A-TID derivation is based on a key derivation function (KDF).

The K_{AKMA} is derived from K_{AUSF}. Since K_{AKMA} and A-TID in A-KID are both derived from K_{AUSF} based on primary authentication run, the K_{AKMA} and A-KID are refreshed by a new successful primary authentication.

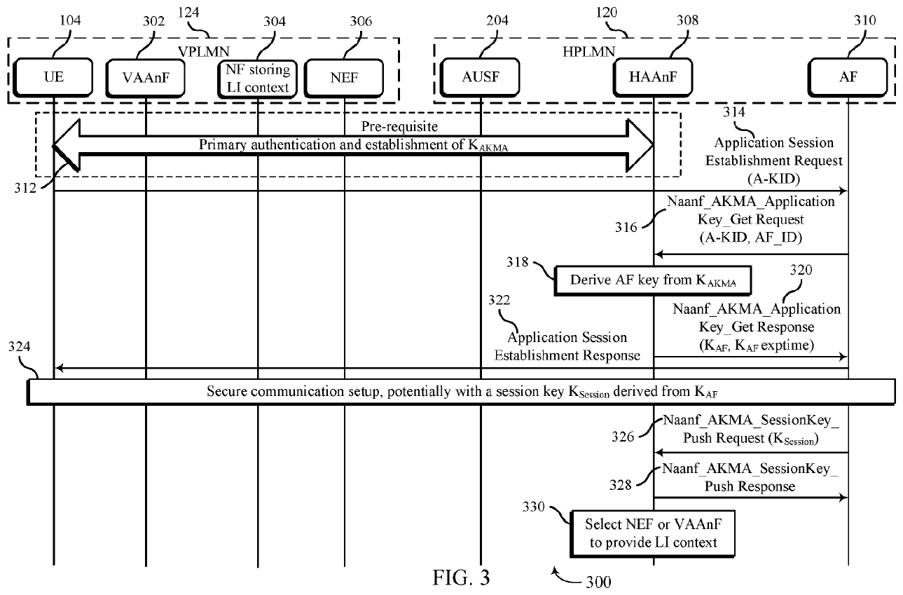

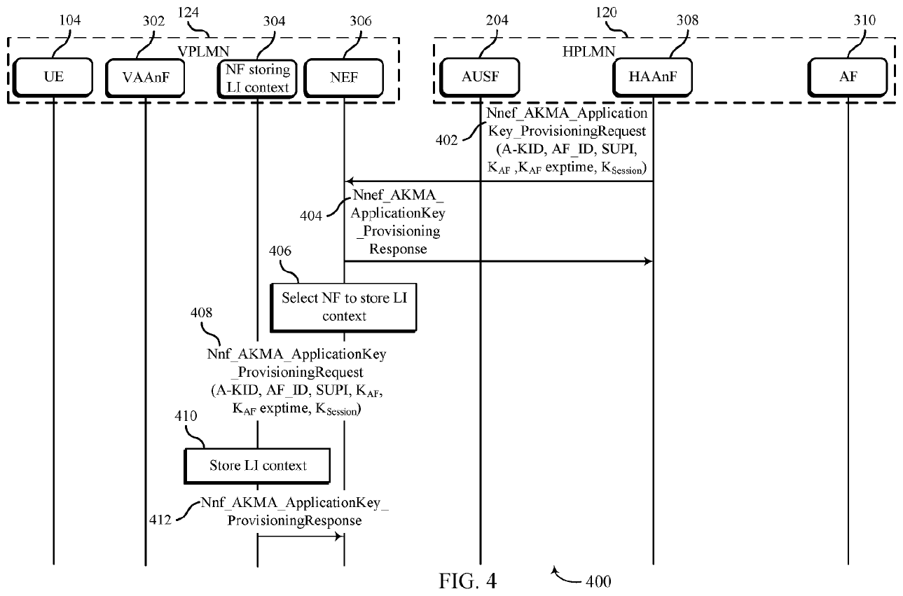

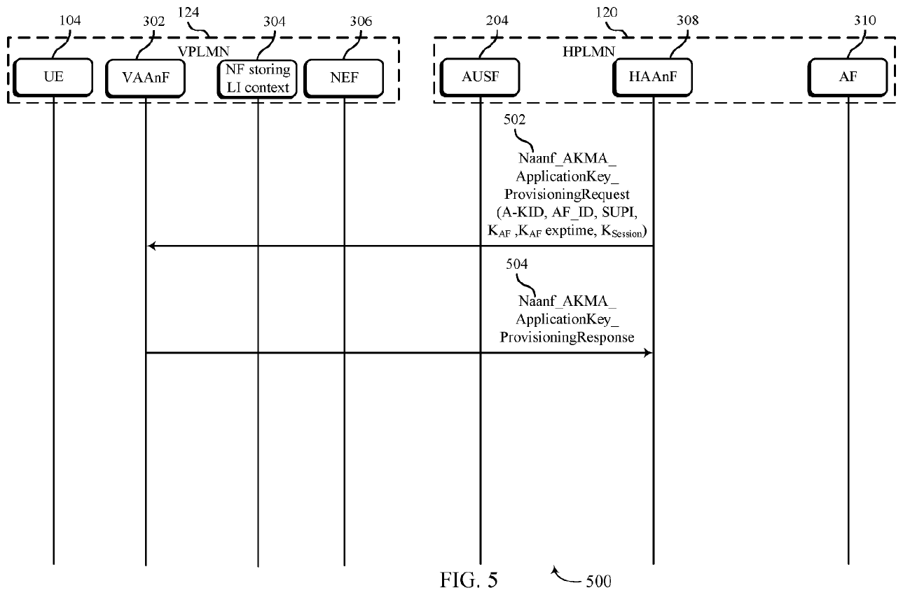

FIGS. 3, 4, and 5 illustrate examples of KAF generation from K_{AKMA} and provisioning to VPLMN that supports providing security keys to a serving network of a user equipment in accordance with aspects of the present disclosure. FIGS. 3 and 4 illustrate examples 300 and 400 of KAF generation from K_{AKMA} and provisioning to VPLMN where there is no AKMA support in the VPLMN 124, policies or SLAs. FIGS. 3 and 5 illustrate examples 300 and 500 of K_{AF} generation from K_{AKMA} and provisioning to VPLMN where there is AKMA support in the VPLMN 124, policies or SLAs.

FIG. 3 illustrates an example 300 of a portion of KAF generation from K_{AKMA} and provisioning to VPLMN that supports providing security keys to a serving network of a user equipment in accordance with aspects of the present disclosure. The example 300 illustrates the VPLMN 124 that includes the UE 104, a VAAnF 302, an NF 304 storing an LI context, and an NEF 306. The example 300 also illustrates the HPLMN 120 that includes the AUSF 204, an HAAnF 308 (which may be the AAnF 208 of FIG. 2), and the AF 310.

At 312, primary authentication is performed and K_{AKMA} is established. In one or more implementations, the primary authentication is performed and K_{AKMA} is established as discussed above in example 200 of FIG. 2.

At 314, the UE 104 generates the AKMA Anchor Key (K_{AKMA}) and the A-KID from the K_{AUSF} before initiating communication with an AKMA AF 310. When the UE 104 initiates communication with the AKMA AF 310, the UE 104 includes the derived A-KID in the Application Session Establishment Request message. The UE 104 may derive K_{AF} before sending the message or afterwards.

At 316, if the AF 310 does not have an active context associated with the A-KID, then the AF 310 selects the HAAnF 308 and sends an Naanf_AKMA_ApplicationKey_Get request to the HAAnF 308 with the A-KID to request the K_{AF} for the UE 104. The AF 310 also includes its identity (AF_ID) in the request.

The AF_ID includes the fully qualified domain name (FQDN) of the AF 310 and the Ua* security protocol identifier. The latter parameter identifies the security protocol that the AF 310 will use with the UE 104.

The HAAnF 308 checks whether the HAAnF 308 can provide the service to the AF 310 based on the configured local policy or based on the authorization information available in the signaling (i.e., Oauth2.0 token). If it succeeds, the following procedures are executed. Otherwise, the HAAnF 308 rejects the procedure.

The HAAnF 308 verifies whether the subscriber is authorized to use AKMA based on the presence of the UE 104 specific K_{AKMA} key identified by the A-KID. If K_{AKMA} is present in HAAnF 308, the HAAnF continues at 318 below. If K_{AKMA} is not present in the HAAnF 308, the HAAnF 308 continues at 320 below with an error response.

At 318, the HAAnF 308 derives the K_{AF} from K_{AKMA} if it does not already have K_{AF}.

At 320, the HAAnF 308 provides the K_{AF} and the K_{AF} expiration time to the AF 310 according to the AKMA procedure. If K_{AKMA} is not present in the HAAnF 308, the HAAnF 308 returns an error response to the AF 310.

At 322, the AF 310 sends an Application Session Establishment Response to the UE 104 according to the AKMA procedure.

At 324, the UE 104 and the AF 310 may perform an additional key derivation from K_{AF} in order to generate a K_{Session} that is used to protect the application session between the UE 104 and the AF 310. The key derivation is depending on the protocol used on the Ua* interface between the UE 104 and the AF 310.

At 326, after the session establishment, the AF 310 provides the K_{Session} to the HAAnF 308 in an Naanf_AKMA_SessionKey_Push_Request. The HAAnF 308 may have subscribed to notifications to the AF 310 on the session key change. This request may be sent with each refresh of the K_{AF} or K_{Session} of the Ua* protocol. The AF 310 may send the SessionKey_Push_Request directly to the NEF 306 in the VPLMN.

At 328, the HAAnF 308 acknowledges the request with an Naanf_AKMA_SessionKey_Push_Response.

At 330, the HAAnF 308 detects based on the SN name that the UE 104 is roaming and if the VPLMN 124 has AKMA LI enhancements. The VPLMN 124 AKMA capabilities and policies may be configured in the HAAnF 308 and may be based on SLAs. Based on the AKMA support in the VPLMN 124, policies or SLAs, the HAAnF 308 selects the NEF 306 (e.g., if there is no AKMA support in the VPLMN 124, policies or SLAs) or the VAAnF 302 (e.g., if there is AKMA support in the VPLMN 124, policies or SLAs). Additionally or alternatively, if the AF 310 cannot reach the NEF 306 in the VPLMN 124 directly, the AF 310 may choose an NEF in the HPLMN 120 (not shown), which forwards the request to the NEF 306 in the VPLMN 124.

FIG. 4 illustrates an example 400 of a portion of KAF generation from K_{AKMA} and provisioning to VPLMN that supports providing security keys to a serving network of a user equipment in accordance with aspects of the present disclosure. The example 400, with the example 300 of FIG. 3, illustrates signaling in situations where, for example, there is no AKMA support in the VPLMN 124, policies or SLAs. The example 400 illustrates the VPLMN 124 that includes the UE 104, the VAAnF 302, the NF 304 storing an LI context, and the NEF 306. The example 400 also illustrates the HPLMN 120 that includes the AUSF 204, the HAAnF 308 (which may be the AAnF 208 of FIG. 2), and the AF 310.

At 402, the HAAnF 308 sends an Nnef_AKMA_ApplicationKey_Provisioning_Request to the NEF 306 in the VPLMN 124. The request may be sent via an NEF in the HPLMN 120 (not shown). The request contains the full security context for LI of the UE 104 for this AKMA session, e.g., A-KID, AF_ID, SUPI, K_{AF}, K_{AF} expiration time, and K_{Session}. Additionally or alternatively, the HAAnF 308 may send the AKMA_ApplicationKey_Provisioning_Request directly to the NF 304 storing the LI context in the VPLMN 124, depending on the configuration in the HAAnF 308 for this VPLMN 124.

At 404, the NEF 306 acknowledges the request with a Nnef_AKMA_ApplicationKey_Provisioning_Response.

At 406, the NEF 306 selects an appropriate NF in the VPLMN 124 that is used to store the LI security context for the inbound roaming UE 104. The selected NF may be any NF in the network, e.g., a UDM, a UDR, an AMF, an SMF, a PCF, an AUSF, an AAnF, and so forth.

At 408, the NEF 306 sends the Nnf_AKMA_ApplicationKey_Provisioning_Request to the selected NF in the VPLMN including the LI security context. The request contains the full security context for LI of the UE 104 for this AKMA session, e.g., A-KID, AF_ID, SUPI, K_{AF}, K_{AF} expiration time, and K_{Session}.

At 410, the NF 304 stores the LI security context for potential LI request in the VPLMN 124. The NF 304 may delete the LI security context after expiration of K_{AF}. In a case of K_{AF} or K_{Session} key refresh, the NF 304 needs to be informed about the new key with the same procedure as discussed above.

At 412, the NF 304 acknowledges the LI security context with a Nnf_AKMA_ApplicationKey_Provisioning_Response.

FIG. 5 illustrates an example 500 of a portion of KAF generation from K_{AKMA} and provisioning to VPLMN that supports providing security keys to a serving network of a user equipment in accordance with aspects of the present disclosure. The example 500, with the example 300 of FIG. 3, illustrates signaling in situations where, for example, there is AKMA support in the VPLMN 124, policies or SLAs. The example 500 illustrates the VPLMN 124 that includes the UE 104, the VAAnF 302, the NF 304 storing an LI context, and the NEF 306. The example 500 also illustrates the HPLMN 120 that includes the AUSF 204, the HAAnF 308 (which may be the AAnF 208 of FIG. 2), and the AF 310.

At 502, the HAAnF 308 provides the KAF and the KAF expiration time together with the SUPI of the UE 104 and the K_{Session} to the VAAnF 302 in the VPLMN 124 for storing the AKMA LI context.

At 504, the VAAnF 302 acknowledges the request.

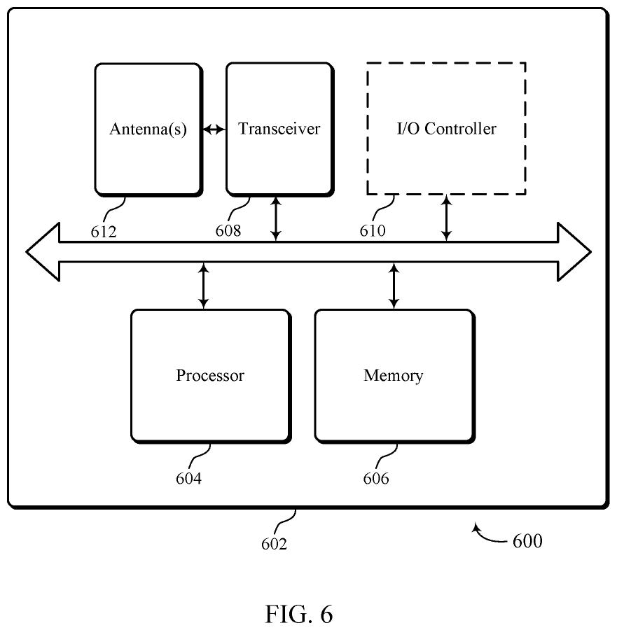

FIG. 6 illustrates an example of a block diagram 600 of a device 602 that supports providing security keys to a serving network of a user equipment in accordance with aspects of the present disclosure. The device 602 may be an example of a network entity that is, or that implements, an HAAnF as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. Processor 604 may be configured as or otherwise support to: receive, from a first network entity in a first network, a first signaling indicating a first request and an application session security key, the apparatus being in the first network; transmit, to a second network entity in a second network, a second signaling indicating a second request and the application session key; receive, from the second network entity, a third signaling indicating acknowledgment of the second request.

Additionally or alternatively, the processor 604 may be configured to or otherwise support: to detect that the second network supports AKMA; and transmit, in response to detecting that the second network supports AKMA, the second signaling to a VAAnF that is the second network entity in the second network; where the second network does not support AKMA and the second network entity comprises a NEF in the second network; where the second signaling further indicates an A-KID, an AF_ID, a SUPI, an KAF, and a KAF expiration time; to transmit, to the first network entity, a fourth signaling indicating acknowledgment of the first request; to transmit the second signaling in response to detecting that a UE is roaming in the second network, the application session security key having been established for secure communication between the UE and the first network entity; where the apparatus implements a HAAnF.

For example, the processor 604 may support wireless communication at the device 602 in accordance with examples as disclosed herein. Processor 604 may be configured as or otherwise support a means for: receiving, from a first network entity in a first network, a first signaling indicating a first request and an application session security key, the method being implemented in the first network; transmitting, to a second network entity in a second network, a second signaling indicating a second request and the application session key; and receiving, from the second network entity, a third signaling indicating acknowledgment of the second request.

Additionally or alternatively, the processor 604 may be configured to or otherwise support: detecting that the second network supports AKMA; and transmitting, in response to detecting that the second network supports AKMA, the second signaling to a VAAnF that is the second network entity in the second network; where the second network does not support AKMA and the second network entity comprises a NEF in the second network; where the second signaling further indicates an A-KID, an AF_ID, a SUPI, an KAF, and a KAF expiration time; transmitting, to the first network entity, a fourth signaling indicating acknowledgment of the first request; transmitting the second signaling in response to detecting that a UE is roaming in the second network, the application session security key having been established for secure communication between the UE and the first network entity; where the method is implemented in a HAAnF.

The processor 604 of the device 602 may support wireless communication in accordance with examples as disclosed herein. The processor 604 may include at least one controller coupled with at least one memory, and may be configured to or operable to cause the processor to perform the techniques discussed herein. For example, the controller may be configured to or operable to cause the processor to receive, from a first network entity in a first network, a first signaling indicating a first request and an application session security key, the apparatus being in the first network; transmit, to a second network entity in a second network, a second signaling indicating a second request and the application session key; receive, from the second network entity, a third signaling indicating acknowledgment of the second request.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

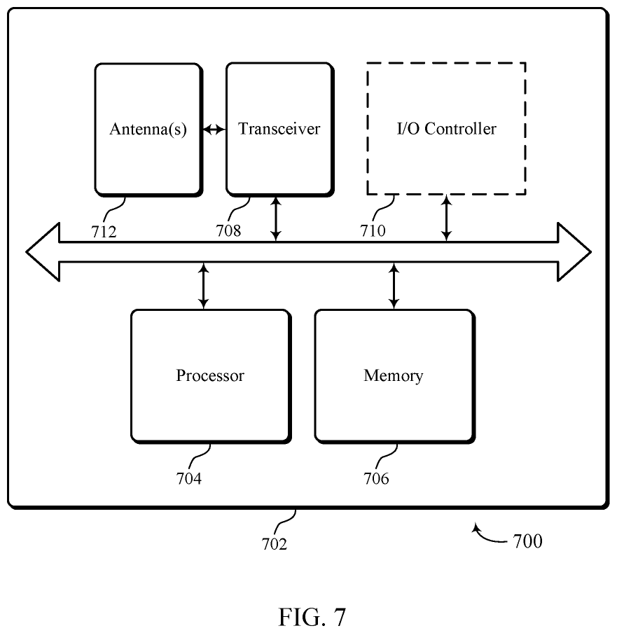

FIG. 7 illustrates an example of a block diagram 700 of a device 702 that supports providing security keys to a serving network of a user equipment in accordance with aspects of the present disclosure. The device 702 may be an example of a network entity that is, or that implements, an NEF as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. Processor 704 may be configured as or otherwise support to: receive, from a first network entity in a first network, a first signaling indicating a first request and an application session security key, the apparatus being in a second network; transmit, to a second network entity in the second network, a second signaling indicating a second request and the application session key; receive, from the second network entity, a third signaling indicating acknowledgment of the second request.

Additionally or alternatively, the processor 704 may be configured to or otherwise support: to select one of multiple NFs in the second network; and transmit the second signaling to the selected one of the multiple NFs, the selected one of the multiple NFs being the second network entity in the second network; where the second signaling further indicates an A-KID, an AF_ID, a SUPI, an KAF, and a KAF expiration time; where the second network entity is one of a UDM, UDR, AMF, SMF, PCF, AUSF, and an AAnF; to transmit, to the first network entity, a fourth signaling indicating acknowledgment of the first request; where the application session security key is a security key for secure communication between a UE that is roaming in the second network and an application function in the first network; where the apparatus implements a NEF.

For example, the processor 704 may support wireless communication at the device 702 in accordance with examples as disclosed herein. Processor 704 may be configured as or otherwise support a means for receiving, from a first network entity in a first network, a first signaling indicating a first request and an application session security key, the method being implemented in a second network; transmitting, to a second network entity in the second network, a second signaling indicating a second request and the application session key; and receiving, from the second network entity, a third signaling indicating acknowledgment of the second request.

Additionally or alternatively, the processor 704 may be configured to or otherwise support: selecting one of multiple NFs in the second network; and transmitting the second signaling to the selected one of the multiple NFs, the selected one of the multiple NFs being the second network entity in the second network; where the second signaling further indicates an A-KID, an AF_ID, a SUPI, an KAF, and a KAF expiration time; where the second network entity is one of a UDM, UDR, AMF, SMF, PCF, AUSF, and an AAnF; transmitting, to the first network entity, a fourth signaling indicating acknowledgment of the first request; where the application session security key is a security key for secure communication between a UE that is roaming in the second network and an application function in the first network; where the method is implemented a NEF.

The processor 704 of the device 702 may support wireless communication in accordance with examples as disclosed herein. The processor 704 may include at least one controller coupled with at least one memory, and may be configured to or operable to cause the processor to perform the techniques discussed herein. For example, the controller may be configured to or operable to cause the processor to receive, from a first network entity in a first network, a first signaling indicating a first request and an application session security key, the apparatus being in a second network; transmit, to a second network entity in the second network, a second signaling indicating a second request and the application session key; receive, from the second network entity, a third signaling indicating acknowledgment of the second request.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

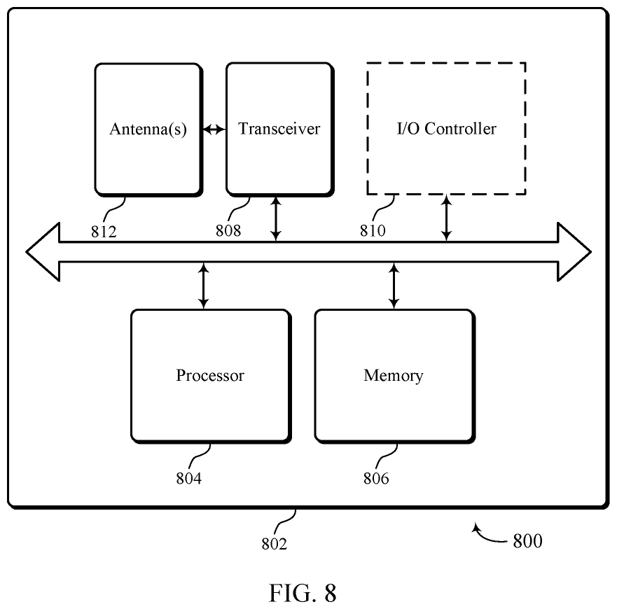

FIG. 8 illustrates an example of a block diagram 800 of a device 802 that supports providing security keys to a serving network of a user equipment in accordance with aspects of the present disclosure. The device 802 may be an example of a network entity that is, or that implements, an NF as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. Processor 804 may be configured as or otherwise support to: receive, from a first network entity in a first network, a first signaling indicating a first request and an application session security key, the apparatus being in the first network; store a LI security context that includes the application session security key; transmit, to the first network entity, a second signaling indicating acknowledgment of the second request.

Additionally or alternatively, the processor 804 may be configured to or otherwise support: where the second signaling further indicates an A-KID, an AF_ID, a SUPI, an KAF, and a KAF expiration time, and the LI security context further includes the AKMA, the A-KID, the AF_ID, the SUPI, the KAF, and the KAF expiration time; to determine that the KAF expiration time has expired; and delete, in response to determining that the KAF expiration time has expired, the LI security context; where the apparatus implements a second network entity that is one of a UDM, UDR, AMF, SMF, PCF, AUSF, and an AAnF; where the application session security key is a security key for secure communication between a UE that is roaming in the first network and an application function in a second network; where the first network entity comprises a NEF.

For example, the processor 804 may support wireless communication at the device 802 in accordance with examples as disclosed herein. Processor 804 may be configured as or otherwise support a means for receiving, from a first network entity in a first network, a first signaling indicating a first request and an application session security key, the method being implemented in the first network; storing a LI security context that includes the application session security key; and transmitting, to the first network entity, a second signaling indicating acknowledgment of the second request.

Additionally or alternatively, the processor 804 may be configured to or otherwise support: where the second signaling further indicates an A-KID, an AF_ID, a SUPI, an KAF, and a KAF expiration time, and the LI security context includes the AKMA, the A-KID, the AF_ID, the SUPI, the KAF, and the KAF expiration time; determining that the KAF expiration time has expired; and deleting, in response to determining that the KAF expiration time has expired, the LI security context; where the method is implemented in a second network entity that is one of a UDM, UDR, AMF, SMF, PCF, AUSF, and an AAnF; where the application session security key is a security key for secure communication between a UE that is roaming in the first network and an application function in a second network; where the first network entity comprises a NEF.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The processor 804 of the device 802 may support wireless communication in accordance with examples as disclosed herein. The processor 804 may include at least one controller coupled with at least one memory, and may be configured to or operable to cause the processor to perform the techniques discussed herein. For example, the controller may be configured to or operable to cause the processor to receive, from a first network entity in a first network, a first signaling indicating a first request and an application session security key, the apparatus being in the first network; store a LI security context that includes the application session security key; transmit, to the first network entity, a second signaling indicating acknowledgment of the second request.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

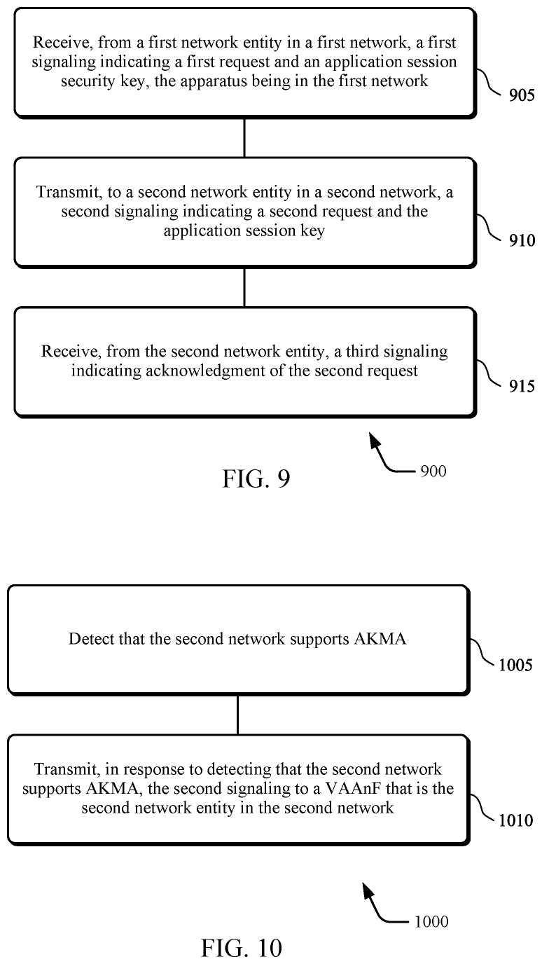

FIG. 9 illustrates a flowchart of a method 900 that supports providing security keys to a serving network of a user equipment in accordance with aspects of the present disclosure. The operations of the method 900 may be implemented by a device or its components as described herein. For example, the operations of the method 900 may be performed by network entity that is, or that implements, an HAAnF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 905, the method may include receiving, from a first network entity in a first network, a first signaling indicating a first request and an application session security key, the apparatus being in the first network. The operations of 905 may be performed in accordance with examples as described herein. In some implementations, aspects of the operations of 905 may be performed by a device as described with reference to FIG. 1.

At 910, the method may include transmitting, to a second network entity in a second network, a second signaling indicating a second request and the application session key. The operations of 910 may be performed in accordance with examples as described herein. In some implementations, aspects of the operations of 910 may be performed by a device as described with reference to FIG. 1.

At 915, the method may include receiving, from the second network entity, a third signaling indicating acknowledgment of the second request. The operations of 915 may be performed in accordance with examples as described herein. In some implementations, aspects of the operations of 915 may be performed by a device as described with reference to FIG. 1.

FIG. 10 illustrates a flowchart of a method 1000 that supports providing security keys to a serving network of a user equipment in accordance with aspects of the present disclosure. The operations of the method 1000 may be implemented by a device or its components as described herein. For example, the operations of the method 1000 may be performed by network entity that is, or that implements, an HAAnF described with reference to FIGS. 1 through 8. In some implementations, the device may execute a set of instructions to control the function elements of the device to perform the described functions. Additionally, or alternatively, the device may perform aspects of the described functions using special-purpose hardware.

At 1005, the method may include detecting that the second network supports AKMA.

The operations of 1005 may be performed in accordance with examples as described herein. In some implementations, aspects of the operations of 1005 may be performed by a device as described with reference to FIG. 1.

At 1010, the method may include transmitting, in response to detecting that the second network supports AKMA, the second signaling to a VAAnF that is the second network entity in the second network. The operations of 1010 may be performed in accordance with examples as described herein. In some implementations, aspects of the operations of 1010 may be performed by a device as described with reference to FIG. 1.

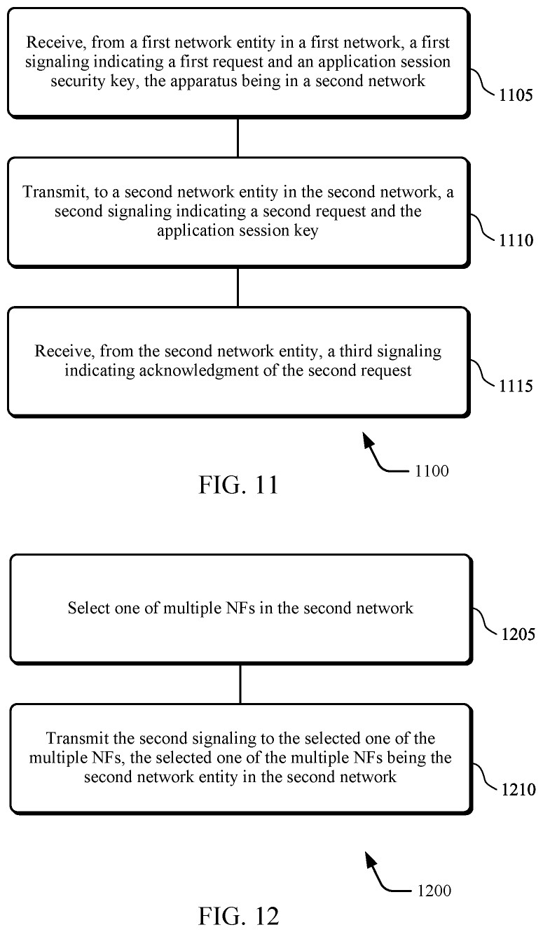

FIG. 11 illustrates a flowchart of a method 1100 that supports providing security keys to a serving network of a user equipment in accordance with aspects of the present disclosure. The operations of the method 1100 may be implemented by a device or its components as described herein. For example, the operations of the method 1100 may be performed by network entity that is, or that implements, an NEF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1105, the method may include receiving, from a first network entity in a first network, a first signaling indicating a first request and an application session security key, the apparatus being in a second network. The operations of 1105 may be performed in accordance with examples as described herein. In some implementations, aspects of the operations of 1105 may be performed by a device as described with reference to FIG. 1.

At 1110, the method may include transmitting, to a second network entity in the second network, a second signaling indicating a second request and the application session key. The operations of 1110 may be performed in accordance with examples as described herein. In some implementations, aspects of the operations of 1110 may be performed by a device as described with reference to FIG. 1.

At 1115, the method may include receiving, from the second network entity, a third signaling indicating acknowledgment of the second request. The operations of 1115 may be performed in accordance with examples as described herein. In some implementations, aspects of the operations of 1115 may be performed by a device as described with reference to FIG. 1.

FIG. 12 illustrates a flowchart of a method 1200 that supports providing security keys to a serving network of a user equipment in accordance with aspects of the present disclosure. The operations of the method 1200 may be implemented by a device or its components as described herein. For example, the operations of the method 1200 may be performed by network entity that is, or that implements, an NEF described with reference to FIGS. 1 through 8. In some implementations, the device may execute a set of instructions to control the function elements of the device to perform the described functions. Additionally, or alternatively, the device may perform aspects of the described functions using special-purpose hardware.

At 1205, the method may include selecting one of multiple NFs in the second network. The operations of 1205 may be performed in accordance with examples as described herein. In some implementations, aspects of the operations of 1205 may be performed by a device as described with reference to FIG. 1.

At 1210, the method may include transmitting the second signaling to the selected one of the multiple NFs, the selected one of the multiple NFs being the second network entity in the second network. The operations of 1210 may be performed in accordance with examples as described herein. In some implementations, aspects of the operations of 1210 may be performed by a device as described with reference to FIG. 1.

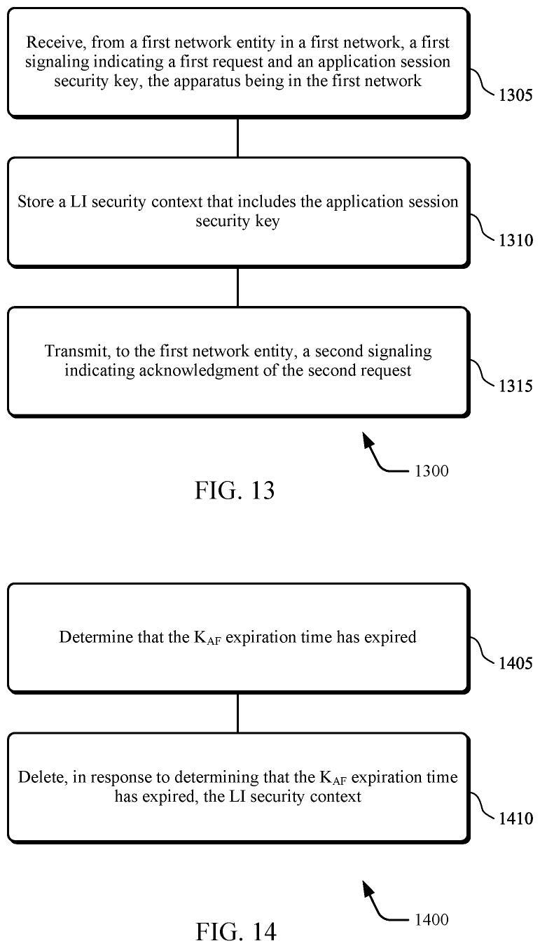

FIG. 13 illustrates a flowchart of a method 1300 that supports providing security keys to a serving network of a user equipment in accordance with aspects of the present disclosure. The operations of the method 1300 may be implemented by a device or its components as described herein. For example, the operations of the method 1300 may be performed by network entity that is, or that implements, an NF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1305, the method may include receiving, from a first network entity in a first network, a first signaling indicating a first request and an application session security key, the apparatus being in the first network. The operations of 1305 may be performed in accordance with examples as described herein. In some implementations, aspects of the operations of 1305 may be performed by a device as described with reference to FIG. 1.

At 1310, the method may include storing a LI security context that includes the application session security key. The operations of 1310 may be performed in accordance with examples as described herein. In some implementations, aspects of the operations of 1310 may be performed by a device as described with reference to FIG. 1.

At 1315, the method may include transmitting, to the first network entity, a second signaling indicating acknowledgment of the second request. The operations of 1315 may be performed in accordance with examples as described herein. In some implementations, aspects of the operations of 1315 may be performed by a device as described with reference to FIG. 1.

FIG. 14 illustrates a flowchart of a method 1400 that supports providing security keys to a serving network of a user equipment in accordance with aspects of the present disclosure. The operations of the method 1400 may be implemented by a device or its components as described herein. For example, the operations of the method 1400 may be performed by network entity that is, or that implements, an NF described with reference to FIGS. 1 through 8. In some implementations, the device may execute a set of instructions to control the function elements of the device to perform the described functions. Additionally, or alternatively, the device may perform aspects of the described functions using special-purpose hardware.

At 1405, the method may include determining that the KAF expiration time has expired. The operations of 1405 may be performed in accordance with examples as described herein. In some implementations, aspects of the operations of 1405 may be performed by a device as described with reference to FIG. 1.

At 1410, the method may include deleting, in response to determining that the KAF expiration time has expired, the LI security context. The operations of 1410 may be performed in accordance with examples as described herein. In some implementations, aspects of the operations of 1410 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on”shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and configured to cause the apparatus to:
receive, from a first network entity in a first network, a first request and an application session security key, wherein the apparatus is in the first network;
transmit, to a second network entity in a second network, a second request and the application session key;
receive, from the second network entity, an acknowledgment of the second request.

2. The apparatus of claim 1, wherein the processor is further configured to cause the apparatus to:
detect that the second network supports authentication and key management for applications (AKMA); and
transmit, in response to detecting that the second network supports AKMA, the second request and the application session key to a visited authentication and key management for applications anchor function (VAAnF), wherein the second network entity comprises the VAAnF.

3. The apparatus of claim 1, wherein the second network does not support authentication and key management for applications (AKMA) and the second network entity comprises a network exposure function (NEF) in the second network.

4. The apparatus of claim 1, wherein the at least one processor is further configured to cause the apparatus to transmit, to the second network entity, an authentication and key management for applications (AKMA) key identifier (A-KID), an application function identity (AF_ID), a subscription permanent identifier (SUPI), an AKMA application key (KAF), or a KAF expiration time.

5. The apparatus of claim 1, wherein the at least one processor is further configured to cause the apparatus to transmit, to the first network entity, an acknowledgment of the first request.

6. The apparatus of claim 1, wherein to transmit the second request and the application session key, the at least one processor is further configured to cause the apparatus to transmit the second request and the application session key in response to detecting that a user equipment (UE) is roaming in the second network, wherein the application session security key has been established for secure communication between the UE and the first network entity.

7. The apparatus of claim 1, wherein the apparatus implements a home authentication and key management for applications anchor function (HAAnF).

8. An apparatus for wireless communication, comprising:
at least one memory; and
at least one processor coupled with the at least one memory and configured to cause the apparatus to:
receive, from a first network entity in a first network, a first request and an application session security key, wherein the apparatus is in a second network;
transmit, to a second network entity in the second network, second request and the application session key;
receive, from the second network entity, an acknowledgment of the second request.

9. The apparatus of claim 8, wherein the at least one processor is further configured to cause the apparatus to:
select one of multiple network functions (NFs) in the second network; and
transmit the second request and the application session key to the selected one of the multiple NFs, wherein the selected one of the multiple NFs comprises the second network entity.

10. The apparatus of claim 8, wherein the at least one processor is further configured to cause the apparatus to transmit, to the second network entity, an authentication and key management for applications (AKMA) key identifier (A-KID), an application function identity (AF_ID), a subscription permanent identifier (SUPI), an AKMA application key (KAF), or a KAF expiration time.

11. The apparatus of claim 8, wherein the second network entity comprises one of a unified data management (UDM) function, a unified data repository (UDR), an access and mobility management function (AMF), a session management function (SMF), a policy control function (PCF), an authentication server function (AUSF), or an authentication and key management for applications anchor function (AAnF).

12. The apparatus of claim 8, wherein the at least one processor is further configured to cause the apparatus to transmit, to the first network entity, an acknowledgment of the first request.

13. The apparatus of claim 8, wherein the application session security key comprises a security key for secure communication between a user equipment (UE) that is roaming in the second network and an application function in the first network.

14. The apparatus of claim 8, wherein the apparatus implements a network exposure function (NEF).

15. An apparatus for wireless communication, comprising:
at least one memory; and
at least one processor coupled with the at least one memory and configured to cause the apparatus to:
receive, from a first network entity in a first network, a first request and an application session security key, wherein the apparatus is in the first network;
store a legal interception (LI) security context that includes the application session security key;
transmit, to the first network entity, an acknowledgment of the request.

16. The apparatus of claim 15, wherein the at least one processor is further configured to cause the apparatus to:
transmit, to the first network entity, an authentication and key management for applications (AKMA) key identifier (A-KID), an application function identity (AF_ID), a subscription permanent identifier (SUPI), an AKMA application key (KAF), and a KAF expiration time, wherein the LI security context further includes the AKMA, the A-KID, the AF_ID, the SUPI, the KAF, and the KAF expiration time;
determine that the KAF expiration time has expired; and
delete, in response to determining that the KAF expiration time has expired, the LI security context.

17. The apparatus of claim 15, wherein the apparatus implements a second network entity that is one of a unified data management (UDM) function, a unified data repository (UDR), an access and mobility management function (AMF), a session management function (SMF), a policy control function (PCF), an authentication server function (AUSF), or an authentication and key management for applications anchor function (AAnF).

18. The apparatus of claim 15, wherein the application session security key is a security key for secure communication between a user equipment (UE) that is roaming in the first network and an application function in a second network.

19. The apparatus of claim 15, wherein the first network entity comprises a network exposure function (NEF).

20. A method, comprising:
receiving, from a first network entity in a first network, a first request and an application session security key, wherein the method is implemented in the first network;
transmitting, to a second network entity in a second network, second request and the application session key; and
receiving, from the second network entity, an acknowledgment of the second request.
